(19) United States
(12) Patent Application Publication
(10) Pub. No.: US 2025/0246834 A1
(43) Pub. Date: Jul. 31, 2025

(54) CONNECTOR FOR FPC CIRCUIT OF POWER BATTERY AND INSTALLATION METHOD OF CONNECTOR

(71) Applicant: Shenzhen Kemin Sensor Co., Ltd., Shenzhen (CN)

(72) Inventor: Qiang ZENG, Shenzhen (CN)

(73) Assignee: Shenzhen Kemin Sensor Co., Ltd., Shenzhen (CN)

(21) Appl. No.: 19/026,061

(22) Filed: Jan. 16, 2025

(30) Foreign Application Priority Data
Jan. 25, 2024 (CN) 202410100660.0

(51) Int. Cl. H01R 12/77; H01R 12/70; H01R 13/52; H01R 13/631

(52) U.S. Cl. CPC H01R 12/777; H01R 12/7011; H01R 13/5216; H01R 13/631

(57) ABSTRACT

Provided are a connector for an FPC (flexible printed circuit) of a power battery, and an installation method of the connector. The connector includes a connector body, metal pins are provided at a closed end of the connector body. Two adjacent metal pins are not in communication. A sealing silicone element is fixedly connected with an open end of the connector body. Multiple first FPC holes corresponding to positions of the metal pins are formed in the sealing silicone element. A connector buckle is fixedly sleeved outside the connector body. The sealing silicone element is abutted against a bottom inner wall of the connector buckle. Second FPC holes corresponding to the first FPC holes are formed in a bottom of the connector buckle. A conductor, after passing through the second FPC hole and the first FPC hole, can be in contact and conduction with the corresponding metal pin.

### CROSS-REFERENCE TO RELATED APPLICATION

This patent application claims the benefit and priority of Chinese Patent Application No. 202410100660.0, entitled “CONNECTOR FOR FPC CIRCUIT OF POWER BATTERY AND INSTALLATION METHOD OF CONNECTOR” filed on Jan. 25, 2024, the disclosure of which is incorporated by reference herein in its entirety as part of the present application.

### TECHNICAL FIELD

The present disclosure relates to the field of connectors for FPC circuit connection, and in particular to a connector for an FPC (flexible printed circuit) of a power battery, and an installation method of the connector.

### BACKGROUND

With the development of new energy vehicles in China, in order to improve the endurance mileage, the wiring harness of the traditional battery management system (BMS) is gradually replaced by flexible printed circuit board (FPC) due to its complicated wiring and large size. The existing FPC connectors are all consumer-grade and industrial-grade, which have the problems of easy loosening and non-moisture-proof, and are not suitable for onboard use. Therefore, the existing FPCs are all welded on a printed circuit board assembly (PCBA), and when one of the circuits is damaged, the FPC and PCBA need to be disassembled and scrapped as a whole, resulting in difficult maintenance and high maintenance cost.

### SUMMARY

The embodiments aim to provide a connector for an FPC of a power battery and an installation method of the connector, thus solving the problems in the prior art. The installation and disassembly are convenient, the maintenance is convenient, and the sealing performance is good.

To achieve the objective above, the present disclosure provides the following technical solution.

The present disclosure provides a connector for an FPC of a power battery, including:
a connector body, where multiple metal pins are provided at a closed end of the connector body, and two adjacent metal pins of the multiple metal pins are not in communication to each other;
a sealing silicone element, where the sealing silicone element is configured to be fixedly connected with an open end of the connector body, and the sealing silicone element is provided with multiple first FPC holes corresponding to multiple metal pins;
a connector buckle, where the connector buckle is fixedly sleeved outside the connector body, the sealing silicone element is abutted against a bottom inner wall of the connector buckle, and second FPC holes corresponding to the multiple first FPC holes are formed in a bottom of the connector buckle; and
the FPC, where the FPC is internally provided with multiple conductors which are separated from each other, each of the multiple conductors, passing through a corresponding one of the second FPC holes and a corresponding one of the multiple first FPC holes, of the FPC is able to be in contact and conduction with a corresponding metal pin of the multiple metal pins, and limiting devices on side walls of the FPC is able to be clamped at fixation positions formed between the connector body and the sealing silicone element, respectively.

In some embodiments, the connector body is made of a plastic material. The multiple metal pins and the connector body are in integrated injection molding. A plastic partition layer is adopted for partition between the two adjacent metal pins of the multiple metal pins.

In some embodiments, each of the multiple metal pins includes a pin elastic sheet and an exposed pin which are integrally molded. The pin elastic sheet is arranged in the connector, and is configured to be in contact and conduction with the corresponding conductor.

In some embodiments, the pin elastic sheet is an irregular-shaped elastic sheet, including an upper elastic sheet and a lower elastic sheet which are symmetrically arranged. A space between the upper elastic sheet and the lower elastic sheet is formed as a contact communication position. One end of each of the multiple conductors can extend between the upper elastic sheet and the lower elastic sheet, and be in contact and conduction with the upper elastic sheet and the lower elastic sheet at the contact communication position.

In some embodiments, the sealing silicone element includes a silicone element body, one end of the silicone element body is provided with bosses, and concave boss seats are arranged in an open end of the connector body. Each of the bosses is able to be clamped in a corresponding one of the concave boss seat, and each of the fixation positions is formed between a tail end of a corresponding one of the concave boss seats and a bottom of a corresponding one of the concave boss seats.

In some embodiments, the connector buckle includes a connector buckle body of a rectangular platy structure, two buckle lugs are symmetrically arranged on the connector buckle body, and an inner side wall of each of the two buckle lugs is in contact connection with an outer side wall of the connector body on a same side. A square hole is formed in each of the two buckle lugs, and undercuts are symmetrically arranged on two outer side walls, connected with the two buckle lugs, of the connector body, and each of the undercuts is able to be clamped in the square hole on a same side. The second FPC holes are formed in the connector body.

In some embodiments, multiple of buckle tongues are fixedly arranged on an inner side of the connector buckle body, multiple buckle tongue through holes are formed in the sealing silicone element, and each of the multiple buckle tongues is able to be inserted into a corresponding one of the multiple buckle tongue through holes.

In some embodiments, the FPC includes an up-down insulating layer. The multiple conductors are arranged in the up-down insulating layer, and each of the limiting devices is fixedly arranged on a corresponding one of two side walls of the up-down insulating layer. A tail end of each of the multiple conductors is in communication with a gold finger, and multiple U-shaped ports are formed in a tail end of the up-down insulating layer. Each of the multiple U-shaped ports is located between two adjacent conductors of the plurality of conductors, and is able to separate two adjacent gold fingers to form a corresponding connecting insert. The connecting insert can be in contact and conduction with a corresponding one of multiple metal pins.

In some embodiments, an insulating gasket is fixedly arranged at a bottom of the up-down insulating layer, and the insulating gasket is located at one end, adjacent to the multiple U-shaped ports, of the up-down insulating layer; and the limiting devices are of a convex clamping structure fixedly arranged on the two side walls of the up-down insulating layer, respectively.

The present disclosure further provides an installation method for a connector for an FPC of a power battery, including:
assembling a connector buckle body with a sealing silicone element, and inserting each of buckle tongues into a corresponding one of buckle tongue through holes;
inserting the FPC into first FPC holes and second FPC holes in turn, and arranging each of limiting devices in front of a corresponding one of bosses of the sealing silicone element; and
inserting the bosses of the sealing silicone element into a corresponding one of boss seats at an open end of a connector body, inserting buckle lugs outside a corresponding one of side walls of the connector body, buckling each of undercuts in a corresponding one of square holes, and communicating each of gold fingers with a corresponding one of pin elastic sheets at a corresponding one of contact communication positions.

Compared with the prior art, the embodiments have the following technical effects.

The FPC is connected with the connector through the combination of the connector body, the sealing silicone element and the connector buckle, a joint is sealed with the sealing silicone element, and the connector buckle is configured to fix the sealing silicone element, FPC contact points and connector elastic sheets, thus achieving the effects of firm and reliable contact of the metal contact of the connector, shock resistance, no looseness, sealing, water resistance and moisture resistance through the combination of the sealing silicone element, the FPC contact points and the connector elastic sheets. The FPC assembly and the PCBA are easy to connect, easy to install and disassemble, thus reaching the automotive grade of vehicles.

### BRIEF DESCRIPTION OF THE DRAWINGS

To describe the technical solutions of the embodiments of the present disclosure Embodiment: or in the prior art more clearly, the following briefly introduces the drawings required for describing the embodiments. Apparently, the drawings in the following description show merely some embodiments of the present disclosure, and those of ordinary skill in the art may still derive other drawings from these drawings without creative efforts.

FIG. 1 is a schematic structural diagram of a connector body according to the present disclosure;

FIG. 2 is a schematic diagram of one side of the connector body according to the present disclosure;

FIG. 3 is a cutaway view of the connector body according to the present disclosure;

FIG. 4 is a schematic diagram of a sealing silicone element according to the present disclosure;

FIG. 5 is a cutaway view of the sealing silicone element according to the present disclosure;

FIG. 6 is a cutaway view of a side surface of the sealing silicone element according to the present disclosure;

FIG. 7 is a schematic structural diagram of a connector buckle according to the present disclosure;

FIG. 8 is a schematic diagram of a side surface of the connector buckle according to the present disclosure;

FIG. 9 is a cutaway view of the connector buckle according to the present disclosure;

FIG. 10 is a sectional view of a side surface of the connector buckle according to the present disclosure;

FIG. 11 is a schematic diagram of an overall assembly of a connector for an FPC of a power battery according to the present disclosure;

FIG. 12 is a schematic diagram of the FPC according to the present disclosure;

FIG. 13 is a schematic diagram of the FPC according to the present disclosure from another angle;

FIG. 14 is a schematic diagram of a connection between the FPC and the connector according to the present disclosure;

FIG. 15 is a side view of FIG. 14;

FIG. 16 is a sectional view of FIG. 14;

FIG. 17 is a sectional view from another angle after the FPC and the connector according to the present disclosure are connected.

List of the reference characters: 1 connector body; 2 undercut; 3 metal pin; 4 pin elastic sheet; 5 plastic partition layer; 6 upper elastic sheet; 7 lower elastic sheet; 8 exposed pin; 9 sealing silicone element; 10 first FPC hole; 11 buckle tongue through hole; 12 connector buckle body; 13 buckle lug; 14 square hole; 15 buckle tongue; 16 FPC; 17 insulating gasket; 18 conductor; 19 convex clamping structure; 20 gold finger; 21 upper and lower insulating layer; 22 U-shaped port; 23 contact communication position; 24 boss; 25 boss seat; 26 fixation position; 27 second FPC hole.

### DETAILED DESCRIPTION OF THE EMBODIMENTS

The following clearly and completely describes the technical solutions in the embodiments of the present disclosure with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a connector for an FPC of a power battery and an installation method of the connector, thus solving the problems in the prior art. The installation and disassembly are convenient, the maintenance is convenient, and the sealing performance is good.

In order to make the objectives, features and advantages of the present disclosure more clearly, the present disclosure is further described in detail below with reference to the drawings and specific embodiments.

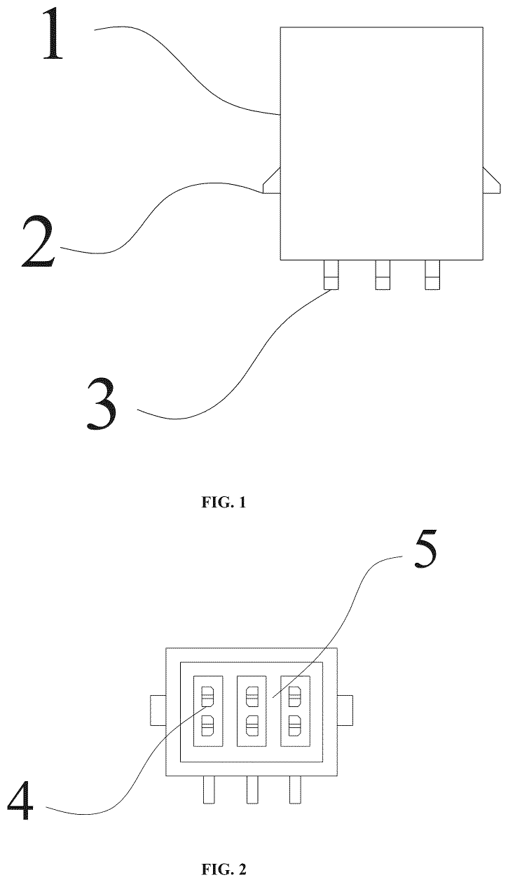

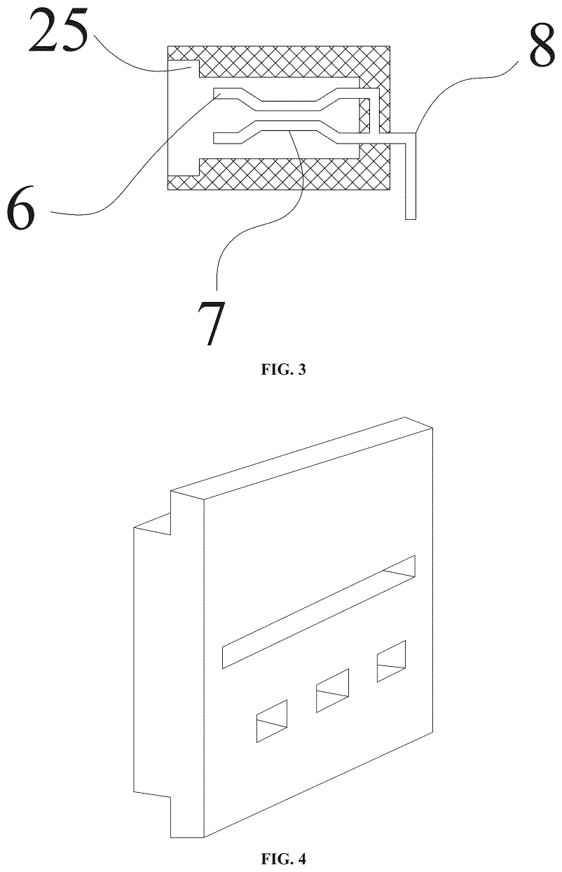

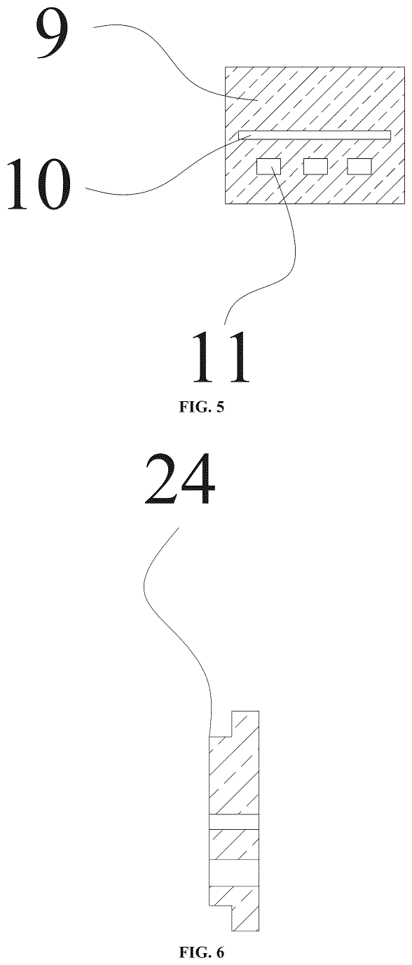

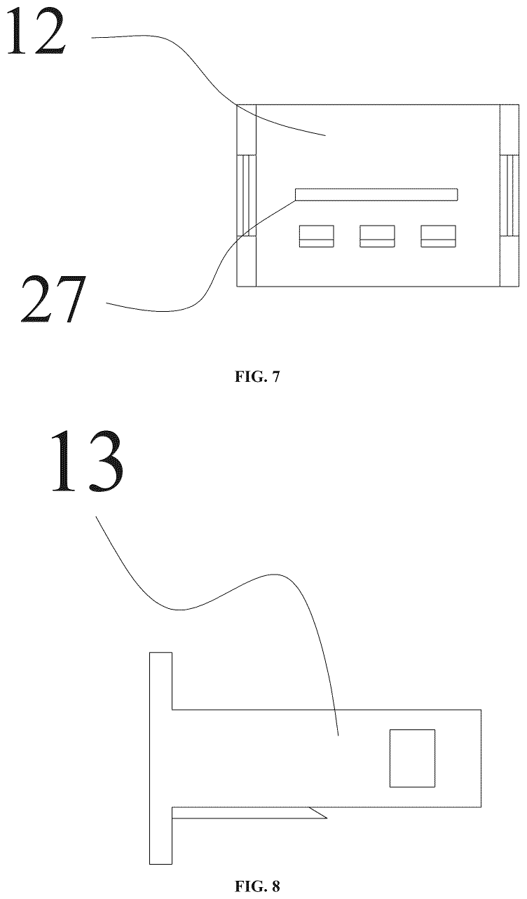

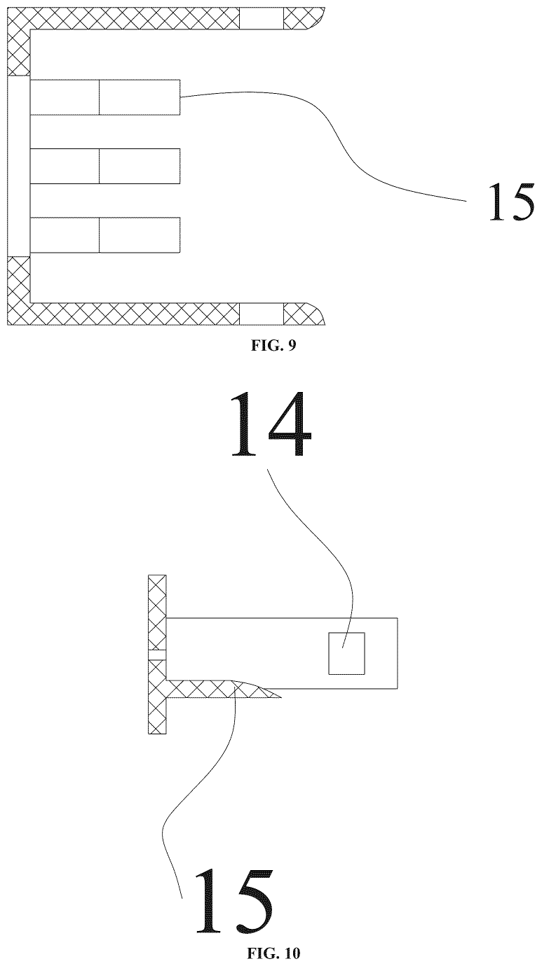

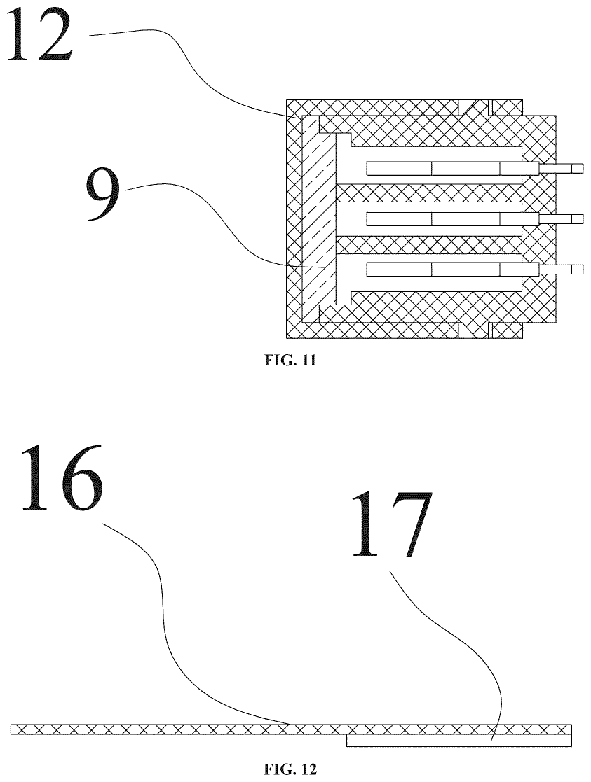

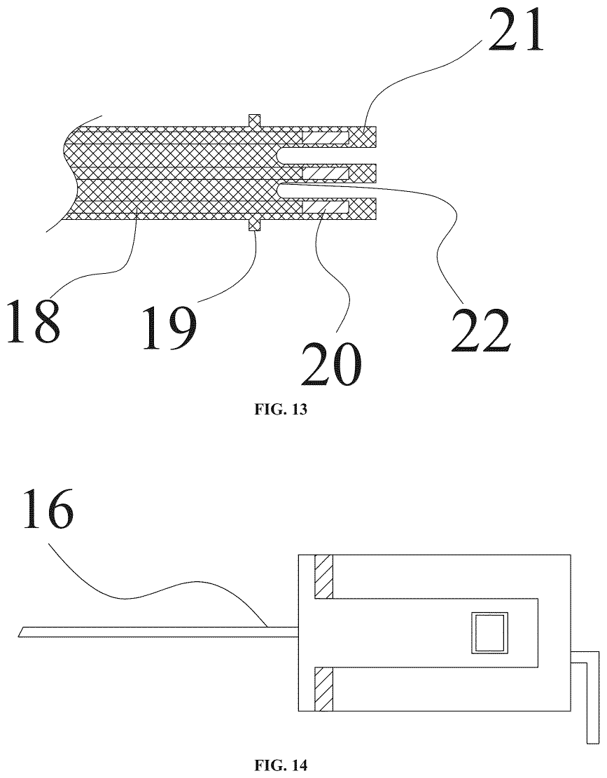

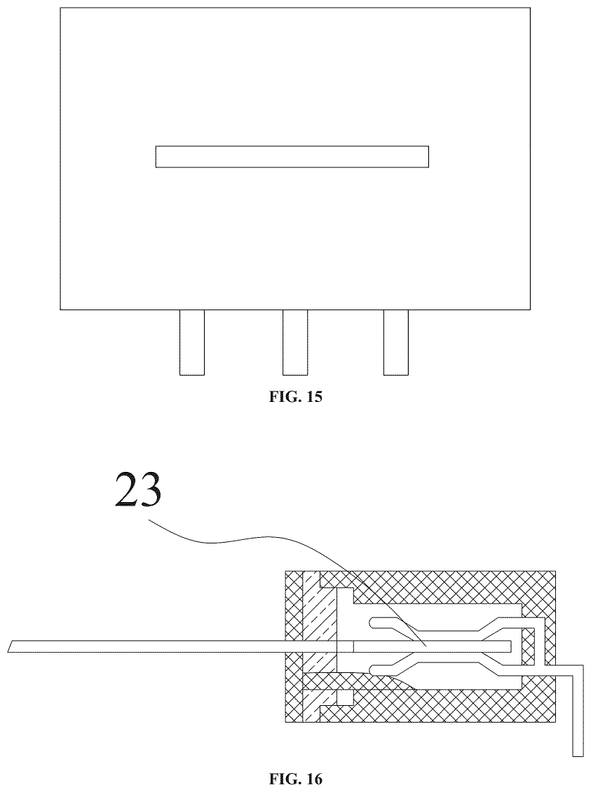

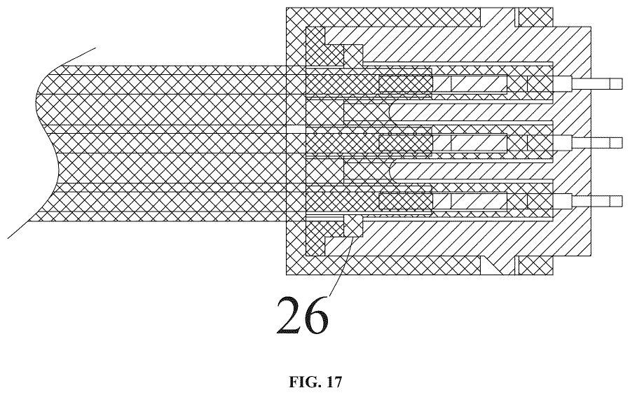

Referring to FIG. 1 to FIG. 17, the present disclosure provides a connector for an FPC of a power battery, including a connector body 12, a sealing silicone element, and a connector buckle. The connector buckle includes a connector buckle body 12. The connector body 1 and the connector buckle body 12 are made of hydrolysis-resistant plastic. The sealing silicone element is made of silicone rubber, or fluororubber. Multiple metal pins 3 are inserted into a closed end of the connector body 1, and the metal pins 3 and the connector body 1 are in integrated injection molding. Two adjacent metal Pins 3 are partitioned by a compartment formed by a plastic partition layer 5, and a single independent compartment is in butt joint with different pin positions of the circuit. In this embodiment, three butted pin positions are adopted as an example to illustrate, the number of the butted pin positions and a spacing therebetween are not limited, and the number of pin positions (socket positions) can be increased or decreased according to application requirements. The sealing silicone element is configured to be fixedly connected with the open end of the connector body 1, and is provided with multiple first FPC holes 10 corresponding to the positions of the metal pins 3. When the sealing silicone element is assembled with the connector body 1, the FPC circuit 16, the connector buckle and the internal compartment of the connector body 1 are sealed by extrusion. The connector buckle is fixedly sleeved outside the connector main body 1, and the sealing silicone element is abutted against a bottom inner wall of the connector buckle. The bottom of the connector buckle is provided with second FPC holes 27 corresponding to the first FPC holes 10, thus facilitating the FPC 16 to pass through. Multiple conductors 18 which are separated from each other are arranged in the FPC 16 of the power battery. The conductor 18 of the FPC 16 passing through the second FPC line hole 27 and the first FPC line hole 10 can be in contact and conduction with the corresponding metal pin 3, and the limiting device on a side wall of the FPC 16 can be clamped at the fixing position 26 formed between the connector body 1 and the sealing silicone member.

In a preferred embodiment, the metal pin 3 includes a pin elastic sheet 4 and an exposed pin 8 which are integrally molded. The pin elastic sheet 4 is an irregular-shaped elastic sheet in the connector, and includes an upper elastic sheet 6 and a lower elastic sheet 7 which are symmetrically arranged. A space between the upper elastic sheet 6 and the lower elastic sheet 7 is formed as a contact communication position 23. One end of the conductor 18 can extend between the upper elastic sheet 6 and the lower elastic sheet 7, and in contact and conduction with the upper elastic sheet 6 and the lower elastic sheet 7 at the contact communication position 23. The exposed pin 8 is configured to conduct with the PCBA.

In order to make the sealing effect better, in this embodiment, the sealing silicone element includes a silicone element body 9, one end of the silicone element body 9 is provided with bosses 24, the open end of the connector body 1 is provided with concave boss seats 25, and the boss 24 can be clamped in the boss seat 25, which is similar to a fitting structure of a bottle mouth and a bottle stopper and can improve the sealing performance. A fixation position 26 is formed at a gap between a tail end of the boss 24 and the bottom of the boss seat 25, which is convenient for the limiting device on the side wall of the FPC 16 for clamping and limiting.

In order to prevent the sealing silicone element from being exposed to the outside and further improve its sealing performance, the connector buckle adopts a connector buckle body 12 of a rectangular plate structure, which can be abutted against an outer side of the sealing silicone element. Two buckle lugs 13 are symmetrically arranged on the connector buckle body 12, and an inner side wall of the buckle lug 13 is in contact connection with an outer side wall of the connector body 1 located on the same side. The buckle lug 13 is provided with a square hole 14, and two outer side walls of the connector body 1 connected with the buckle lugs 13 are symmetrically provided with undercuts 2. The undercut 2 can be clamped in the square hole 14 on the same side, such that the connector buckle can be fixed to the connector body 1. Multiple buckle tongues 15 are fixed to an inner side of the connector buckle body 12, multiple buckle tongue through holes 11 are formed in the sealing silicone element, and the buckle tongue 15 can be inserted into the corresponding buckle tongue through hole 11. After the gold finger 20 is in contact with the pin elastic sheet 4 on the connector body 1, the gold finger 20 is jacked up by the buckle tongue 15, and thus is tightly attached and cannot be loosened.

In order to facilitate the insertion and the conduction of the circuit, the FPC 16 is provided with an up-down insulating layer 21, multiple conductors 18 are arranged in the up-down insulating layer 21, and the limiting devices are fixedly arranged on two side walls of the up-down insulating layer 21. The surface of the gold finger 20 is electroplated, and thus is corrosion resistant, high-conduction and friction resistant. A tail end of the up-down insulating layer 21 is provided with multiple U-shaped ports 22. The U-shaped port 22 is located between two adjacent conductors 18, and can separate the two adjacent gold fingers 20 to form a corresponding connecting insert. The U-shaped ports 22 are configured for avoiding the compartment in the connector, thus making the FPC inserted into the connector. The connecting insert can be in contact and conduction with the corresponding pin 3. An insulating gasket 17 is fixedly arranged at the bottom of the up-down insulating layer 21, and the insulating gasket 17 is located at one end close to the U-shaped port 22. The insulating gasket is arranged from a position of the limiting device and has a thickness of 0.3-0.8 mm and more. The limiting device is of a convex clamping structure 19 fixedly arranged on each of two side walls of the up-down lower insulating layer 21.

The present disclosure further provides an installation method of a connector for an FPC of a power battery, including the following steps: assembling a connector buckle body 12 with a sealing silicone element, and inserting a buckle bot 15 into a buckle tongue through hole 11; inserting the FPC 16 into a second FPC hole 27 and a first FPC hole 10 in turn, and arranging a limiting device in front of the boss 24; inserting a boss 24 of the sealing silicone element into a boss seat 25 at an open end of the connector body 1, inserting a buckle lug 13 outside a side wall of the connector body 1, buckling an undercut 2 in a square hole 14, and communicating a gold finger 20 with a pin elastic sheet 4 at a contact communication position to complete the assembling. The joints are sealed with the sealing silicone element, and the connector buckle is configured to fix the sealing silicone element, an FPC circuit contact points and the elastic sheets of the connector, thus achieving the effects of firm and reliable contact of the metal contact of the connector, shock resistance, no looseness, sealing, water resistance and moisture resistance through the combination of the sealing silicone element, the FPC contact point and the connector elastic sheet.

In the description of the present disclosure, it should be noted that the orientation or positional relationship indicated by terms “center”, “top”, “bottom”, “left”, “right”, “vertical”, “horizontal”, “inside” and “outside” is based on the orientation or positional relationship shown in the drawings only for convenience of description of the present disclosure and simplification of description rather than indicating or implying that the device or element referred to must have a particular orientation, be constructed and operate in a particular orientation, and thus are not to be construed as limiting the present disclosure. Furthermore, the terms “first” and “second” are used for descriptive purposes only and are not to be construed as indicating or implying relative importance.

Specific examples are used herein for illustration of the principles and embodiments of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A connector for an FPC (flexible printed circuit) of a power battery, comprising:
a connector body, wherein a plurality of metal pins are provided at a closed end of the connector body, and two adjacent metal pins of the plurality of metal pins are not in communication to each other;
a sealing silicone element, wherein the sealing silicone element is configured to be fixedly connected with an open end of the connector body, and the sealing silicone element is provided with a plurality of first FPC holes corresponding to the plurality of metal pins;
a connector buckle, wherein the connector buckle is fixedly sleeved outside the connector body, the sealing silicone element is abutted against a bottom inner wall of the connector buckle, and second FPC holes corresponding to the plurality of first FPC holes are formed in a bottom of the connector buckle; and
the FPC, wherein the FPC is internally provided with a plurality of conductors which are separated from each other, each of the plurality of conductors, passing through a corresponding one of the second FPC holes and a corresponding one of the plurality of first FPC holes, of the FPC is able to be in contact and conduction with a corresponding metal pin of the plurality of metal pins, and limiting devices on side walls of the FPC are able to be clamped at fixation positions formed between the connector body and the sealing silicone element, respectively.

2. The connector for an FPC of a power battery according to claim 1, wherein the connector body is made of a plastic material, the plurality of metal pins and the connector body are in integrated injection molding; and a plastic partition layer is adopted for partition between the two adjacent metal pins of the plurality of metal pins.

3. The connector for an FPC of a power battery according to claim 1, wherein each of the plurality of metal pins comprises a pin elastic sheet and an exposed pin which are integrally molded, the pin elastic sheet is located in the connector and is configured to be in contact and conduction with the corresponding conductor of the plurality of conductors.

4. The connector for an FPC of a power battery according to claim 2, wherein the pin elastic sheet is an irregular-shaped elastic sheet, comprising an upper elastic sheet and a lower elastic sheet which are symmetrically arranged; a space between the upper elastic sheet and the lower elastic sheet is formed as a contact communication position; and one end of each of the plurality of conductors is able to extend between the upper elastic sheet and the lower elastic sheet, and be in contact and conduction with the upper elastic sheet and the lower elastic sheet at the contact communication position.

5. The connector for an FPC of a power battery according to claim 1, wherein the sealing silicone element comprises a silicone element body, one end of the silicone element body is provided with bosses, and concave boss seats are arranged in an open end of the connector body, and each of the bosses is able to be clamped in a corresponding one of the concave boss seats, and each of the fixation positions is formed between a tail end of a corresponding one of the concave boss seats and a bottom of a corresponding one of the concave boss seats.

6. The connector for an FPC of a power battery according to claim 1, wherein the connector buckle comprises a connector buckle body of a rectangular platy structure, two buckle lugs are symmetrically arranged on the connector buckle body, and an inner side wall of each of the two buckle lugs is in contact connection with an outer side wall of the connector body on a same side;
a square hole is formed in each of the two buckle lugs, and undercuts are symmetrically arranged on two outer side walls, connected with the two buckle lugs, of the connector body, and each of the undercuts is able to be clamped in the square hole on a same side; and the second FPC holes are formed in the connector body.

7. The connector for an FPC of a power battery according to claim 6, wherein a plurality of buckle tongues are fixedly arranged on an inner side of the connector buckle body, a plurality of buckle tongue through holes are formed in the sealing silicone element, and each of the multiple buckle tongues is able to be inserted into a corresponding one of the multiple buckle tongue through holes.

8. The connector for an FPC of a power battery according to claim 1, wherein the FPC comprises an up-down insulating layer; the plurality of conductors are arranged in the up-down insulating layer, each of the limiting devices is fixedly arranged on a corresponding one of two side walls of the up-down insulating layer; a tail end of each of the plurality of conductors is in communication with a gold finger, and a plurality of U-shaped ports are formed in a tail end of the up-down insulating layer; and each of the plurality of U-shaped ports is located between two adjacent conductors of the plurality of conductors and is able to separate two adjacent gold fingers to form a corresponding connecting insert; and the connecting insert is able to be in contact and conduction with a corresponding one of the plurality of metal pins.

9. The connector for an FPC of a power battery according to claim 8, wherein an insulating gasket is fixedly arranged at a bottom of the up-down insulating layer, and the insulating gasket is located at one end, adjacent to the plurality of U-shaped ports, of the up-down insulating layer; and the limiting devices are of a convex clamping structure fixedly arranged on the two side walls of the up-down insulating layer, respectively.

10. An installation method of a connector for an FPC of a power battery, comprising:
assembling a connector buckle body with a sealing silicone element, and inserting each of buckle tongues into a corresponding one of buckle tongue through holes;
inserting the FPC into first FPC holes and second FPC holes in turn, and arranging each of limiting devices in front of a corresponding one of bosses of the sealing silicone element; and
inserting the bosses of the sealing silicone element into a corresponding one of boss seats at an open end of a connector body, inserting buckle lugs outside a corresponding one of side walls of the connector body, buckling each of undercuts in a corresponding one of square holes, and communicating each of gold fingers with a corresponding one of pin elastic sheets at a corresponding one of contact communication positions.
